(19) United States
(12) Patent Application Publication
(10) Pub. No.: US 2006/0165933 A1
(43) Pub. Date: Jul. 27, 2006

(54) Rolled bellows with a large radius of curvature

(76) Inventors: Achim Pfeifer, Sankt Augustin (DE); Joachim Prolss, Ober-Ramstadt (DE); Wolfgang Lobel, Frankfurt/Main (DE); Claus Disser, Deligenstadt (DE); Joachim Dorr, Hennef (DE)

Correspondence Address: ARTZ & ARTZ, P.C., 28333 TELEGRAPH RD., SUITE 250, SOUTHFIELD, MI, 48034, US

(21) Appl. No.: 10/562,562

(22) PCT Filed: Sep. 25, 2004
(86) PCT No.: PCT/EP04/10789

§ 371 Date: Feb. 22, 2006

(30) Foreign Application Priority Data
Oct. 15, 2003 (DE) 103 48 646.1

(51) Int. Cl. B29C 47/00

(52) U.S. Cl. 428/36.9

(57) ABSTRACT

A rolling boot (10) for sealing two rotating parts (21, 22), which can be articulated and axially displaceable relative to one another. The rolling boot (10) has a first collar (11) with a smaller diameter for being secured on a first rotational part (11) with a smaller diameter, a second collar (12) with a larger diameter for being secured on a second rotational part (12) with a larger diameter, and an annular wall (13) whose diameter widens from the first collar (11) to the second collar (12). The annular wall (13), when the boot is at rest and unclamped, in half a longitudinal section, extends in an S-shaped way with an inner curvature next to the smaller first collar (11) and with an outer curvature next to the larger second collar (12).

### BACKGROUND

The invention relates to a rolling boot for sealing two rotational parts which rotate together, which can be articulated relative to one another and/or which are axially displaceable relative to one another. The rolling boot has a longitudinal and symmetry axis A, and comprises the following: a first collar with a smaller diameter for being secured on a first rotational part with a smaller diameter, a second collar with a larger diameter for being secured on a second rotational part with a larger diameter, and an annular wall whose diameter widens from the smaller first collar to the larger second collar. Depending on the application, such rolling boots consist of rubber elastomer or plastic elastomer or certain mixtures. Depending on the material, they are produced by injection moulding or blow moulding. While being in the process of being produced, prior art rolling boots each comprise a conical annular wall which extends from the smaller first collar to the larger second collar and which, after having been removed from the mould, are folded backwards from the larger collar in such a way that the second larger collar, axially, is positioned so as to be relatively close to the smaller first collar as well as radially outside the annular wall which, in consequence, is positioned so as to be partially radially double-walled. There is thus obtained a half-torus-shaped formation which, in the longitudinal half-section, comprises a substantially C-shaped curvature apex which, axially, is furthest removed from the first collar and the second collar.

In drawing illustrations of rolling boots of this type it is assumed that the curvature in the mounted condition of the rolling boot is substantially uniform and of a maximum size, if the internal stresses in the material are minimized.

For the purpose of reducing the internal stresses of a rolling boot in the mounted condition, it is proposed in the applicant's DE 102 31 075 that the annular wall which is conical during the production process should initially be fully folded over from the inside to the outside and then, starting from this configuration, it should be folded back towards the smaller collar. In this case, too, it is assumed in the drawing that there is achieved a uniformly large maximum radius of curvature of the rolling boot.

In actual fact, the drawing of rolling boots produced in accordance with the initially mentioned method is idealised. In reality, disadvantageous irregular radii of curvature form at the annular wall in the mounted condition of the boot. In addition, the static boot configuration is largely irrelevant for the service life of the rolling boot because it applies to low speeds only. Under the influence of centrifugal forces which are typical of the load spectrum of such rolling boots and are predominant, prior art rolling boots are deformed in such a way that a relatively sharp kink is formed in the region of the second larger collar, which kink, more particularly with first and second rotational parts which rotate and are articulated relative to one another, leads to considerable flexing in the annular wall, which limits the service life of the rolling boot.

### SUMMARY OF THE INVENTION

It is therefore an object of the invention to provide a rolling boot of said type which, under the influence of centrifugal forces, exhibits a more advantageous forming behaviour and thus promises a longer service life.

A first solution provides that the annular wall, in the condition of being produced, at the unclamped-in rolling boot, in the longitudinal half-section, extends in an S-shaped way with an inner curvature next to the smaller first collar and with an outer curvature next to the larger second collar. Even in the static, built-in condition, the rolling boot described here—as compared to rolling boots according to the state of the art—comprises a more favorable increased radius of curvature of the annular wall in the region of the curvature apex. Furthermore, said increased radius of curvature in the region of the curvature apex is maintained even under the influence of centrifugal forces, i.e. also when the rotational parts rotate, so that the service life of rolling boots in accordance with the invention can be prolonged considerably. The S-shaped extension of the annular wall as visible in the longitudinal half-section is substantially such that the annular wall, in the condition of being produced, at the unclamped-in rolling boot, adjoins the smaller first collar so as to extend approximately axis-parallel relative to the longitudinal axis A and/or that the annular wall, in the condition of being produced, at the unclamped-in rolling boot, adjoins the larger second collar so as to extend approximately axis-parallel to longitudinal axis A. Depending on the type of the subsequent load with reference to the mutual articulation of the rotational parts and, respectively, the mutual axial displacement of the rotational parts, said axial extension of the rolling boot in the condition of being produced can be more or less straight, i.e. the length of the annular wall in the axial direction can be adapted to the respective application. With certain given load spectra, shortened annular wall lengths are possible as compared to prior art rolling boots.

A second solution provides that the annular wall, in the condition of being produced, at the unclamped-in rolling boot, in the longitudinal half-section, extends in a C-shaped way, having an inner curvature between the smaller first collar and the larger second collar. In this case, too, the qualitative effects and advantages as compared to rolling boots in accordance with the state of the art are the same as in the case of the first solution. From the point of view of shaping and production, the simple overall shape is advantageous. With rolling boots of this type, too, the radius of curvature in the region of the curvature apex under the influence of centrifugal forces is greater than in prior art rolling boots.

The terms, in the condition of being produced, at the unclamped-in rolling boot, are synonymous with at rest and unclamped, and will be used interchangeably herein.

According to an advantageous embodiment of the second solution, the annular wall, in the condition of being produced, at the unclamped-in rolling boot adjoins the smaller first collar so as to extend approximately axis-parallel to the longitudinal axis A. Furthermore, according to one embodiment, the annular wall, in the condition of being produced, at the unclamped-in rolling boot, in the longitudinal half-section, adjoins the larger second collar at an acute angle relative to the longitudinal axis A.

Because of the overall reduction in flexing, which is due to the larger radii of curvature, undesirable temperature increases in the boot wall are avoided, which has an advantageous effect on the service life of the boot and on the service life of the grease filling enclosed in the boot.

According to an advantageous further embodiment, the smaller first collar is inwardly thickened relative to the annular wall. It is thus possible to avoid contact between the annular wall and the rotational part with the smaller diameter when the rotational parts are articulated relative to one another. According to a further advantageous embodiment, the smaller first collar, on its outside, comprises an annular groove for receiving a tensioning strip. In this way it is possible to prevent the first collar from being longitudinally displaced on the first rotational part, and preferably, an annular groove is also provided on the outside of the first rotational part.

According to a further advantageous embodiment, the larger second collar is provided in the form of a rounded bead. This is particularly advantageous in a case of cooperation with an annular attaching cap, with the second collar being beaded into same. Such an attaching cap in the form of the second rotational part or as transition piece towards the second rotational part can comprise a cylindrical shape which starts from the second collar. Under the influence of centrifugal forces, the annular wall can partly rest against the inner wall of said attaching cap. This has been taken into account in the intended advantageous form of the radius of curvature of the annular wall subjected to the influence of centrifugal forces.

Furthermore, on the inside of the smaller first collar there a ventilation channel in the form of longitudinal grooves circumferentially offset relative to one another and of a circumferential groove connecting the latter. In addition, at the smaller first collar, axially opposite the annular wall, there is arranged a thin-walled protective sleeve which, at is free end, comprises the shortest distance from the longitudinal axis A.

### BRIEF DESCRIPTION OF THE DRAWINGS

Preferred embodiments of the invention are illustrated in the drawings and will be described below.

FIG. 1 shows a first embodiment of an inventive rolling boot in the condition of being produced:

A) in a longitudinal section; and

B) in a perspective view.

FIG. 2 is a longitudinal half-section of the rolling boot according to FIG. 1:

A) in the condition of being produced;

B) in the folded-over mounted condition free from centrifugal forces; and

C) in the folded-over mounted condition under the influence of centrifugal forces.

FIG. 3 shows a second embodiment of an inventive rolling boot in the condition of being produced:

A) in a longitudinal section; and

B) in a perspective view.

FIG. 4 is a longitudinal half-section through the rolling boot according to FIG. 3:

A) in the condition of being produced;

B) in the folded-over mounted condition free from centrifugal forces; and

C) in the folded-over mounted condition under the influence of centrifugal forces.

### DETAILED DESCRIPTION OF THE DRAWINGS

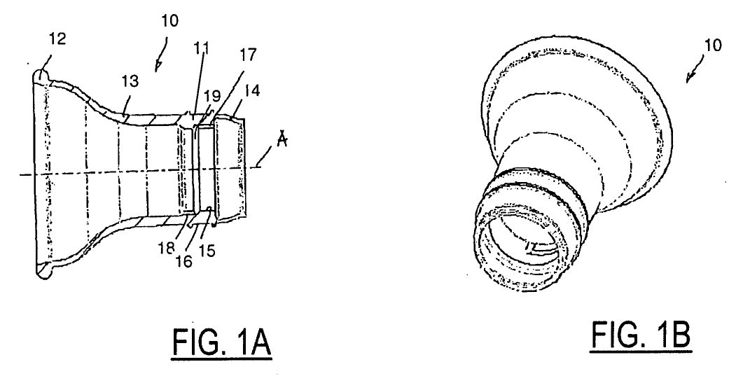

The two illustrations of FIG. 1 will be described jointly below. They show an inventive rolling boot 10 in the condition of being produced after having been removed from its mould. The rolling boot is annular-symmetric relative to a longitudinal axis A. The rolling boot is shown in its most low-stress, self-adjusting condition. That is, the rolling boot is at rest and unclamped. The rolling boot is shown to comprise a first collar 11 with a smaller diameter and a second collar 12 with a larger diameter. The two are connected by an annular wall 13 whose diameter widens from the first collar to the second collar and which is produced so as to be integral with both collars. The first collar 11 is followed by a thin-walled protective sleeve 14 whose smallest diameter is provided at the free end of same. The first collar 11 is to be fixed on a first rotational part, more particularly a driveshaft and comprises a substantially internally cylindrical seat face 15 and, on its outside, an annular groove 16 in which a tensioning strip can be fixed axially. A ventilation system inside the first collar 11 comprises two longitudinal grooves 17, 18 which are circumferentially offset relative to one another, as well as a circumferential groove 19 positioned between the longitudinal grooves 17, 18 and connected thereto. There is thus ensured a constant exchange of gas pressure between the interior of the rolling boot and the surroundings of the mounted rolling boot. The protective sleeve 14 prevents the direct penetration of dirt into the longitudinal groove 17.

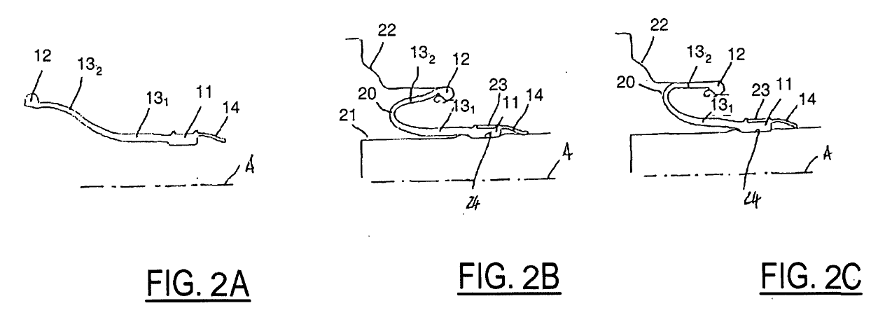

The second collar 12 is shown to be substantially rounded and bead-shaped on its outside and is thus suitable for being beaded into an annular attaching cap. As will be explained below, the condition of production as illustrated here is not identical with the condition of the boot when in use. This will be explained in connection with FIG. 2.

FIG. 2 shows the rolling boot according to FIG. 1 in a longitudinal half-section, with the longitudinal axis A also being shown, but circumferential edges have been eliminated to simplify the illustration. The purpose of FIG. 2A is to show that the annular wall 13 comprises a first portion 13₁ which, in the longitudinal half-section, adjoins the first collar 11 so as to extend approximately axis-parallel to the axis A and which comprises an inner curvature in the longitudinal half-section. There then follows a second portion 13₂ which, in the longitudinal half-section, adjoins the second collar 12 so as to extend approximately axis-parallel to the longitudinal axis A and which comprises an outer curvature in the longitudinal half-section. In the longitudinal half-section, said wall is thus substantially S-shaped with a curvature reversal point between the two portions 13₁ and 13₂.

In FIG. 2B, the same rolling boot is shown for the first time in its mounted position in a stationary condition, i.e., at rest and clamped. It again shows the longitudinal axis A and in addition, a first journal-shaped rotational member 21 and an annular-cap-shaped second rotational member 22 of which only the contour facing the rolling boot is illustrated. A tensioning strip 23 which clamps the first collar 11 on to the shaft journal 21 is slipped on to the first collar 11. The free end of the protective sleeve 14 is positioned on the shaft journal 21. The first collar 11 is positioned in a circumferential groove 24 of the shaft journal 21. In the region of the annular wall 13, the rolling boot is folded over, so that, if viewed radially, it has been doubled, with the second collar 12 coming to rest axially relatively closely to the first collar 11 outside the first portion 13₁ of the annular wall. The rolling boot assumes a curvature in the longitudinal half-section, which curvature is largely constant in one direction, with the reversal point of the curvature, in the longitudinal half-section, if existing, having moved close to the second collar 12. In a three-dimensional sense, the rolling boot now has the shape of half a torus whose smallest radius of curvature in the longitudinal section is positioned in the region of the apex 20.

FIG. 2C shows the rolling boot in the mounted condition under the influence of centrifugal forces. The second portion 13₂ largely contacts the inside of the second rotational member 22. The smallest radius of curvature continues to be positioned in the region of the apex 20 and has advantageously increased relative to the embodiment shown in FIG. 2B. More particularly, it is now larger than that of rolling boots in accordance with the state of the art.

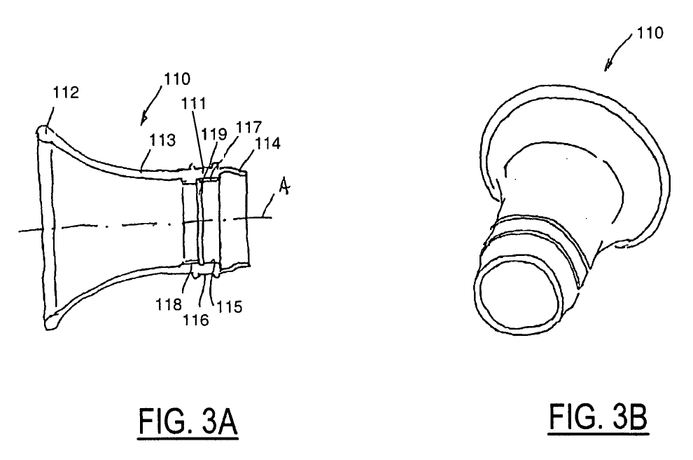

The two illustrations of FIG. 3 will be described jointly below. They show an inventive rolling boot 110 in the condition of being produced after having been removed from its mould. The rolling boot is annular symmetric relative to a longitudinal axis A. The rolling boot is shown in its most low-stress, self-adjusting condition, i.e., at rest and unclamped. The rolling boot is shown to comprise a first collar 111 with a smaller diameter and a second collar 112 with a larger diameter. The two are connected by an annular wall 113 whose diameter widens from the first collar to the second collar and which is produced so as to be integral with both collars. The first collar 111 is followed by a thin-walled protective sleeve 114 whose smallest diameter is provided at the free end of same. The first collar 111 is to be fixed on a first rotational part, more particularly a driveshaft and comprises a substantially internally cylindrical seat face 115 and, on its outside, an annular groove 116 in which a tensioning strip can be fixed axially. A ventilation system inside the first collar 111 comprises two longitudinal grooves 117, 118 which are circumferentially offset relative to one another, as well as a circumferential groove 119 positioned between the longitudinal grooves 117, 118 and connected thereto. There is thus ensured a constant exchange of gas pressure between the interior of the rolling boot and the surroundings of the mounted rolling boot. The protective sleeve 114 prevents the direct penetration of dirt into the longitudinal groove 117.

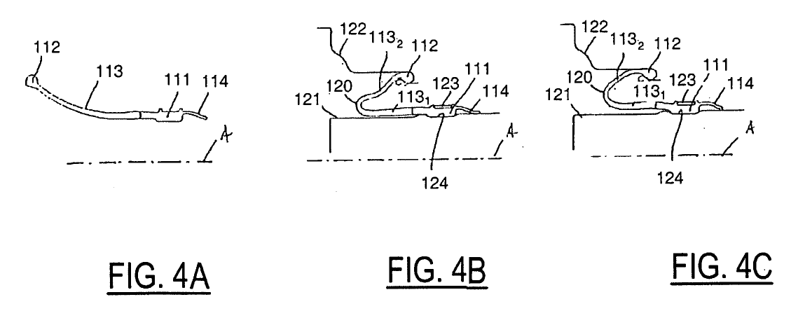

The second collar 112 is shown to be substantially rounded and bead-shaped on its outside and is thus suitable for being beaded into an annular attaching cap. As will be explained below, the condition of production as illustrated here is not identical with the condition of the boot when in use. This will be explained in connection with FIG. 4.

FIG. 4 shows the rolling boot according to FIG. 3 in a longitudinal half-section, with the longitudinal axis A also being shown, but circumferential edges have been eliminated to simplify the illustration. The purpose of FIG. 4A is to show that the annular wall 113 in the longitudinal half-section adjoins the first collar 111 so as to extend approximately axis-parallel to the axis A and comprises an inner curvature in the longitudinal half-section. The annular wall 113, in the longitudinal half-section, adjoins the second collar 112 so as to extend at an acute angle relative to the longitudinal axis A. In the longitudinal half-section, the wall is thus substantially C-shaped.

In FIG. 4B, the same rolling boot is shown for the first time in its mounted position in a stationary condition, i.e., at rest and clamped. It again shows the longitudinal axis A and in addition, a first journal-shaped rotational member 121 and an annular-cap-shaped second rotational member 122 of which only the contour facing the rolling boot is illustrated. A tensioning strip 123 which clamps the first collar 111 on to the shaft journal 121 is slipped on to the first collar 111. The free end of the protective sleeve 114 is positioned on the shaft journal 121. The first collar 111 is positioned in a circumferential groove 124 of the shaft journal 121. In the region of the annular wall 13, the rolling boot is folded over, so that, if viewed radially, it has been doubled, with the second collar 112 coming to rest axially relatively closely to the first collar 111, with a second portion 113₂ being positioned outside the first portion 113₁ of the annular wall. In a three-dimensional sense, the rolling boot now has the shape of a deformed half-torus whose smallest radius of curvature in the longitudinal section is positioned in the region of the apex 120.

FIG. 4C shows the rolling boot in the mounted condition under the influence of centrifugal forces. The second portion 113₂ partly contacts the plate metal cap 122. The smallest radius of curvature continues to be positioned in the region of the apex 120 and has advantageously increased relative to the embodiment shown in FIG. 4B. More particularly, it is now greater than that of rolling boots in accordance with the state of the art.

What is claimed is:

1. A rolling boot for sealing two rotational parts which rotate together, and which can be articulated or axially displaceable relative to one another, comprising:
a first collar with a first diameter for being secured on a first rotational part with a smaller diameter,
a second collar with a second diameter for being secured on a second rotational part with a larger diameter, the first diameter being smaller than the second diameter; and
an annular wall whose diameter widens from the first collar to the second collar,
wherein the annular wall, when the boot is at rest and unclamped, in a longitudinal half-section, extends in one layer in a continuously widening S-shaped way with an inward curvature next to the first collar and with an outward curvature next to the second collar; and
wherein the annular wall, in a pre-stressed condition due to having been folded over, after assembly, in the longitudinal half-section, extends in a partially doubled-up condition in a C-shaped way between the first collar and the second collar.

2.-12. (canceled)

13. A rolling boot according to claim 1, wherein the annular wall, when the boot is at rest and unclamped, adjoins the first collar so as to extend approximately axis-parallel relative to a longitudinal boot axis (A).

14. A rolling boot according to claim 1, wherein the annular wall, when the boot is at rest and unclamped, adjoins the second collar so as to extend approximately axis-parallel relative to a longitudinal boot axis (A).

15. A rolling boot according to claim 13, wherein the annular wall, when the boot is at rest and unclamped, adjoins the second collar so as to extend approximately axis-parallel relative to the longitudinal boot axis (A).

16. A rolling boot for sealing two rotational parts which rotate together, and which can be articulated or axially displaceable relative to one another, comprising:
a first collar with a smaller diameter for being secured on a first rotational part with a smaller diameter;
a second collar with a second diameter for being secured on a second rotational part with a larger diameter, the first diameter being smaller than the second diameter; and
an annular wall whose diameter widens from the first collar to the second collar,
wherein the annular wall, when the boot is at rest and unclamped, in a longitudinal half-section, extends in one layer in a continuously widening C-shaped way with an inward curvature between the first collar and the second collar,
and wherein the annular wall, in a pre-stressed condition due to having been folded over and the boot clamped in, in the longitudinal half-section, extends in a partially doubled-up C-shaped way between the first collar and the second collar.

17. A rolling boot according to claim 16, wherein the annular wall, when the boot is at rest and unclamped, adjoins the first collar so as to extend approximately axis-parallel relative to a longitudinal boot axis (A).

18. A rolling boot according to claim 16, wherein the annular wall, when the boot is at rest and unclamped, in the longitudinal half-section, adjoins the second collar at an acute angle relative to a longitudinal boot axis (A).

19. A rolling boot according to claim 17, wherein the annular wall, when the boot is at rest and unclamped, in the longitudinal half-section, adjoins the second collar at an acute angle relative to the longitudinal boot axis (A).

20. A rolling boot according to claim 1, wherein the first collar is inwardly thickened relative to the annular wall.

21. A rolling boot according to claim 16, wherein the first collar is inwardly thickened relative to the annular wall.

22. A rolling boot according to claim 1, wherein the first collar, on its outside, comprises an annular groove for receiving a tensioning strip.

23. A rolling boot according to claim 16, wherein the first collar, on its outside, comprises an annular groove for receiving a tensioning strip.

24. A rolling boot according to claim 1, wherein the second collar is in the form of a rounded bead.

25. A rolling boot according to claim 16, wherein the second collar is in the form of a rounded bead.

26. A rolling boot according to claim 24, wherein the second collar is beaded into an annular attaching cap.

27. A rolling boot according to claim 25, wherein the second collar is beaded into an annular attaching cap.

28. A rolling boot according claim 1, wherein, an inside of the first collar includes a ventilation channel comprising longitudinal grooves circumferentially offset relative to one another, and a circumferential groove connecting the longitudinal grooves.

29. A rolling boot according claim 16, wherein, an inside of the first collar includes a ventilation channel comprising longitudinal. grooves circumferentially offset relative to one another, and a circumferential groove connecting the longitudinal grooves.

30. A rolling boot according to claim 1 comprising a thin-walled protective sleeve at the first collar, axially opposite the annular wall, a free end of the sleeve being at the shortest distance from a longitudinal boot axis (A).

31. A rolling boot according to claim 16 comprising a thin-walled protective sleeve at the first collar, axially opposite the annular wall, a free end of the sleeve being at the shortest distance from a longitudinal boot axis (A).
